(19) United States
(12) Patent Application Publication
(10) Pub. No.: US 2014/0106725 A1
(43) Pub. Date: Apr. 17, 2014

(54) Distraction Avoidance System

(71) Applicant: HAND HELD PRODUCTS, INC., Fort Mill, SC (US)

(72) Inventor: James Timothy Sauerwein, JR., Charlotte, NC (US)

(73) Assignee: HAND HELD PRODUCTS, INC., Fort Mill, SC (US)

(21) Appl. No.: 13/780,158

(22) Filed: Feb. 28, 2013

Related U.S. Application Data
(60) Provisional application No. 61/714,407, filed on Oct. 16, 2012.

(51) Int. Cl. H04W 4/04

(52) U.S. Cl. CPC H04W 4/046
USPC 455/418

(57) ABSTRACT

A mobile device includes a motion sensing device, a distraction source, and a processor communicatively coupled to the motion sensing device and distraction source. The processor is configured for disabling the distraction source in response to a threshold amount of motion sensed by the motion sensing device.

### CROSS-REFERENCE TO PRIORITY APPLICATION

This application hereby claims the benefit of pending U.S. Provisional Patent Application No. 61/714,407 for a “Distraction Avoidance System” (filed Oct. 16, 2012 at the United States Patent and Trademark Office), which is hereby incorporated by reference in its entirety.

### FIELD OF THE INVENTION

The present invention relates to the field of mobile device systems, more specifically, to a distraction avoidance system for mobile devices.

### BACKGROUND

Distracted driving is a major global issue that impacts thousands of lives and causes millions of dollars in lost productivity and property loss. Furthermore, distracted driving impacts private consumers as well as commercial businesses.

Currently, mobile phone users have many options available to prevent distracted driving—from ignoring incoming calls and messages to turning the device off while driving. Parents forbid their children from driving and texting, and corporations adopt policies banning use of cell phones while driving. However, all of these solutions ultimately rely on the user to actively participate in the process (i.e., the user must obey the rules).

Therefore, a need exists for a mobile device that can prevent distracted driving and does not rely on a mobile device user's active participation or obedience of a rule to do so.

### SUMMARY

Accordingly, in one aspect, the present invention embraces a mobile device including a motion sensing device, a user-interface system, a wireless communication system and a processor communicatively coupled to the motion sensing device, the user-interface system, and the wireless communication system. The user-interface system includes a tactile-control system, and the processor is configured for disabling the user-interface system's tactile-control system in response to a threshold amount of motion sensed by the motion sensing device.

In an exemplary embodiment, the processor is configured for, after disabling the user-interface system's tactile-control system in response to a threshold amount of motion sensed by the motion sensing device, enabling the user-interface system's tactile-control system in response to an amount of motion sensed by the motion sensing device that is less than the threshold amount.

In another exemplary embodiment, the mobile device includes two or more motion sensing devices and the processor is configured for determining an amount of motion in response to data from two or more of the motion sensing devices.

In yet another exemplary embodiment, the mobile device includes a notification system, the processor is communicatively coupled to the notification system, and the processor is configured for disabling the notification system in response to a threshold amount of motion sensed by the motion sensing device.

In yet another exemplary embodiment, the mobile device includes a notification system and the processor is communicatively coupled to the notification system. Additionally, the processor is configured for, when the motion sensing device senses a threshold amount of motion, activating an audio-only notification via the notification system in response to an incoming voice call or message received by the wireless communication system.

In yet another exemplary embodiment, the user-interface system includes a voice-control system and the processor is configured for enabling the voice-control system in response to a threshold amount of motion sensed by the motion sensing device.

In yet another exemplary embodiment, the user-interface system includes a voice-control system and the processor is configured for, when the motion sensing device senses a threshold amount of motion, enabling the voice-control system in response to an incoming voice call or message received by the wireless communication system.

In yet another exemplary embodiment, the processor is configured for, when the motion sensing device senses a threshold amount of motion, directing incoming calls to a voicemail system.

In yet another exemplary embodiment, the motion sensing device includes a GPS device.

In yet another exemplary embodiment, the motion sensing device includes an assisted GPS device.

In yet another exemplary embodiment, the motion sensing device includes an accelerometer.

In yet another exemplary embodiment, the motion sensing device includes a gyro.

In yet another exemplary embodiment, the motion sensing device includes a magnetic compass.

In yet another exemplary embodiment, the motion sensing device includes a cellular radio.

In yet another exemplary embodiment, the motion sensing device includes a camera.

In yet another exemplary embodiment, the tactile-control system includes a keyboard.

In yet another exemplary embodiment, the tactile-control system includes a touch screen.

In yet another exemplary embodiment, the mobile device includes a voice-control system that includes a Bluetooth communication link.

In yet another exemplary embodiment, the mobile device includes a voicemail system.

In yet another exemplary embodiment, the mobile device includes a management system that is communicatively coupled to the processor. The management system is capable of changing the configuration of the processor in response to instructions received by the wireless communication system from a central management authority.

In another aspect, the present invention embraces a mobile device that includes a motion sensing device, a wireless communication system, and a processor communicatively coupled to the motion sensing device and the wireless communication system. The processor is configured for routing incoming calls received by the wireless communication system to a voicemail system when the motion sensing device senses a threshold amount of motion.

In an exemplary embodiment, the mobile device includes a notification system. The processor is communicatively coupled to the notification system and is configured for disabling the notification system in response to a threshold amount of motion sensed by the motion sensing device.

In another exemplary embodiment, the mobile device includes a notification system. The processor is communicatively coupled to the notification system and is configured for, when the motion sensing device senses a threshold amount of motion, activating an audio-only notification via the notification system in response to an incoming call.

In yet another exemplary embodiment, the mobile device includes a tactile-control system and a voice-control system. The processor is communicatively coupled to the tactile-control system and the voice-control system. The processor is configured for disabling the tactile-control system in response to a threshold amount of motion sensed by the motion sensing device and enabling the voice-control system in response to a threshold amount of motion sensed by the motion sensing device.

In yet another exemplary embodiment, the mobile device includes a management system that changes the configuration of the processor in response to instructions received by the wireless communication system from a central management authority.

In yet another aspect, the present invention embraces a mobile device that includes a motion sensing device, a distraction source, and a processor communicatively coupled to the motion sensing device and the distraction source. The processor is configured for disabling the distraction source in response to a threshold amount of motion sensed by the motion sensing device.

In an exemplary embodiment, the processor is configured for, after disabling the distraction source in response to a threshold amount of motion sensed by the motion sensing device, enabling the distraction source in response to an amount of motion sensed by the motion sensing device that is less than the threshold amount.

In another exemplary embodiment, the mobile device includes two or more motion sensing devices and the processor is configured for determining an amount of motion in response to data from two or more of the motion sensing devices.

In yet another exemplary embodiment, the mobile device includes two or more distraction sources and the processor is configured for disabling two or more distraction sources in response to a threshold amount of motion sensed by the motion sensing device.

In yet another exemplary embodiment, the motion sensing device includes a GPS device.

In yet another exemplary embodiment, the motion sensing device includes an assisted GPS device.

In yet another exemplary embodiment, the motion sensing device includes an accelerometer.

In yet another exemplary embodiment, the motion sensing device includes a gyro.

In yet another exemplary embodiment, the motion sensing device includes a magnetic compass.

In yet another exemplary embodiment, the motion sensing device includes a cellular radio.

In yet another exemplary embodiment, the motion sensing device includes a camera.

In yet another exemplary embodiment, the distraction source includes human-readable content.

In yet another exemplary embodiment, the distraction source includes a user interface.

In yet another exemplary embodiment, the distraction source includes a keyboard.

In yet another exemplary embodiment, the distraction source includes a voice communication system.

In yet another exemplary embodiment, the distraction source includes a Bluetooth communication link.

In yet another exemplary embodiment, the distraction source includes a touch screen.

In yet another exemplary embodiment, the distraction source includes a display screen.

In yet another exemplary embodiment, the distraction source includes an audio output device.

In yet another exemplary embodiment, the distraction source includes a voice communication system and the processor is configured for, when the voice communication system is disabled in response to a threshold amount of motion sensed by the motion sensing device, directing incoming calls to a voicemail system.

In yet another exemplary embodiment, the mobile device includes a voicemail system.

In yet another exemplary embodiment, the mobile device includes a wireless communication system and a management system that are both communicatively coupled to the processor. The management system changes the configuration of the processor in response to instructions received by the wireless communication system from a central management authority.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 schematically depicts a communication network that includes an exemplary mobile device according to the present invention.

FIG. 2 schematically depicts a communication network that includes another exemplary mobile device according to the present invention.

### DETAILED DESCRIPTION

The present invention embraces a mobile device (e.g., a cellular phone, a smart-phone, a personal digital assistant, a portable or mobile computer, and/or a tablet device) that can prevent distracted driving and does not rely on a mobile device user's active participation or obedience of a rule to do so. Typically, the mobile device includes at least one motion sensing device communicatively coupled to a processor. In exemplary embodiments, the processor is configured to enable, disable, or control other systems or devices in response to a threshold amount of motion sensed by the motion sensing device.

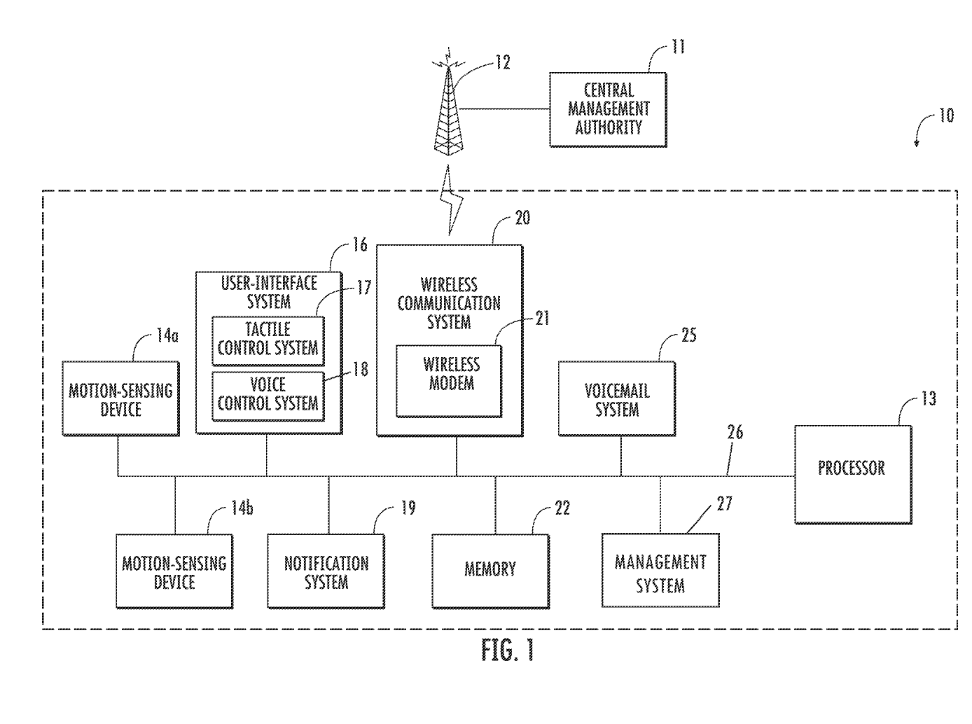

FIG. 1 schematically depicts a communication network that includes an exemplary mobile device according to the present invention. The communication network includes a central management authority 11, a cellular network 12, and an exemplary mobile device 10.

The cellular network 12 is a typical radio network, such as a GSM network, CDMA network, or LTE network, that is capable of providing voice and/or data service to the mobile device 10 connected to the cellular network 12. In particular, the cellular network 12 can send voice and/or data signals to the mobile device 10 and receive voice and/or data signals from the mobile device 10.

As depicted, the exemplary mobile device 10 includes a processor 13, motion sensing devices 14a and 14b, a user-interface system 16, a notification system 19, a wireless communication system 20, memory 22, a voicemail system 25, and a management system 27. The processor 13 is communicatively coupled to each of the other systems and devices.

Exemplary mobile devices may include a system bus 26 and/or one or more interface circuits (not shown) for coupling the processor, systems, and devices to the system bus 26. In this regard, the processor 13 may be communicatively coupled to each of the other systems and devices via the system bus 26 and/or the interface circuits. Similarly, the systems and devices (e.g., the motion sensing devices 14a and 14b, the user-interface system 16, the notification system 19, the wireless communication system 20, memory 22, the voicemail system 25, and the management system 27) may each be communicatively coupled to other systems and devices via the system bus 26 and/or the interface circuits. Other embodiments of system bus architecture providing for efficient data transfer and/or communication between the components of the device may be also be employed in exemplary embodiments in accordance with the present invention.

Typically, the processor 13 is configured to execute instructions and to carry out operations associated with the mobile device 10. For example, using instructions retrieved from memory 22 (e.g., a memory block), the processor 13 may control the reception and manipulation of input and output data between components of the mobile device 10. The processor 13 typically operates with an operating system to execute computer code and produce and use data. The operating system, other computer code, and data may reside within a memory block 22 that is operatively coupled to the processor 13. The memory block 22 generally provides a place to store computer code and data that are used by the mobile device 10. The memory block 22 may include Read-Only Memory (ROM), Random-Access Memory (RAM), a hard disk drive, and/or other non-transitory storage media. The operating system, other computer code, and data may also reside on a removable non-transitory storage medium that is loaded or installed onto the mobile device 10 when needed. Exemplary removable non-transitory storage media include CD-ROM, PC-CARD, memory card, floppy disk, magnetic tape, a network component, and/or a cloud.

The motion sensing devices 14a and 14b are capable of sensing that the mobile device 10 is in motion. The exemplary mobile device 10 depicted in FIG. 1 includes two motion sensing devices 14a and 14b. Other exemplary mobile devices in accordance with the present invention may include more than two motion sensing devices. Furthermore, in some exemplary embodiments, the mobile device includes only one motion sensing device.

Suitable motion sensing devices 14a and 14b include GPS devices, assisted GPS devices (i.e., a device that uses GPS information as well as content provided by land-based cellular towers), accelerometers, gyros, magnetic compasses, cellular radios, and cameras.

In an exemplary mobile device 10 including a GPS or assisted GPS device, the velocity of the mobile device 10 can be calculated from the GPS or assisted GPS information. The processor 13 can determine whether the velocity corresponds to an amount of motion that corresponds to or exceeds a threshold amount of motion.

In exemplary embodiments including an accelerometer, gyro, magnetic compass, cellular radio, and/or camera, motion can be inferred from the data provided by these kinds of motion sensing devices. For example, changes in magnetic compass readings or changes in cell ID as provided by a cellular radio can be used to infer motion of the device. Additionally, video analytics on images acquired by a camera can be used to infer motion of the device.

Generally speaking, the processor 13 aggregates some or all of the data from the motion sensing devices 14a and 14b to determine if the mobile device 10 is in motion. If the amount of motion sensed by the motion sensing device or devices 14a and 14b corresponds to or exceeds the threshold amount of motion, the processor 13 will then enable, disable, or control other systems or devices in the mobile device 10 depending on the processor's configuration.

For example, as depicted in FIG. 1, the user-interface system 16 includes a tactile-control system 17 and a voice-control system 18. The tactile-control system 17 may include a keyboard, touch screen, and/or any other user-input device that is physically manipulated by a user. The voice-control system 18 may be a voice-activated personal assistant or other system that controls or manipulates the mobile device 10 in response to a user's voice commands. The voice-control system 18 may include a Bluetooth communication link to provide a wireless connection to accessories or other external systems.

In exemplary embodiments, the processor 13 is configured for disabling the tactile-control system 17 in response to a threshold amount of motion sensed by the motion sensing devices 14a and 14b. Disabling the tactile-control system 17 while the mobile device 10 is in motion prevents a user of the mobile device 10 from becoming distracted by physically manipulating the mobile device 10. For example, disabling the mobile device's keyboard and/or touch screen prevents the user of the mobile device 10 from accessing device applications, such as e-mail readers, SMS communications, or games. Disabling a system or device may include preventing user input or manipulation of the system or device (e.g., disabling the touch-sensitive aspect or function of a touch screen) and/or cutting off power to the system or device (e.g., turning off the display or touch screen).

In exemplary embodiments, the processor 13 is configured for disabling the voice-control system 18 in response to a threshold amount of motion sensed by the motion sensing devices 14a and 14b. Again, disabling the voice-control system 18 while the mobile device 10 is in motion prevents a user of the mobile device 10 from becoming distracted by using the mobile device 10. For example, disabling the mobile device's Bluetooth communication link prevents the user of the mobile device 10 from using ancillary inputs.

In other exemplary embodiments, the processor 13 may be configured for enabling the voice-control system 18 in response to a threshold amount of motion sensed by the motion sensing devices 14a and 14b. Alternatively, the processor 13 may be configured for, when the motion sensing devices 14a and 14b sense a threshold amount of motion, enabling the voice-control system 18 in response to an incoming voice call or message. Enabling the voice-control system 18 encourages a user of the mobile device 10 to use the voice-control system 18 rather than the tactile-control system 17. Thus, the configuration of the processor 13 in such exemplary embodiments encourages the use of the less distracting voice-control system 18.

In yet another exemplary embodiment, the processor 13 may be configured for disabling the tactile-control system 17 and enabling the voice-control system 18 in response to a threshold amount of motion sensed by the motion sensing devices 14a and 14b. Thus, the configuration of the processor 13 in this exemplary embodiment compels the use of the less distracting voice-control system 18.

As depicted in FIG. 1, the mobile device 10 includes a notification system 19. The notification system 19 provides audio and/or visual notifications on the mobile device 10 in response to incoming voice calls or messages received by the wireless communication system 20. The processor 13 may be configured for disabling the notification system 19 in response to a threshold amount of motion sensed by the motion sensing devices 14a and 14b. Alternatively, the processor may be configured for, when the motion sensing devices 14a and 14b sense a threshold amount of motion, activating audio-only notifications via the notification system 19 in response to incoming voice calls or messages received by the wireless communication system 20.

In exemplary embodiments, the processor 13 may be configured for, after disabling a device or system (e.g., the tactile-control system 17, voice-control system 18, and/or notification system 19) in response to a threshold amount of motion sensed by the motion sensing devices 14a and 14b, enabling the previously disabled device or system in response to an amount of motion sensed by the motion sensing devices 14a and 14b that is less than the threshold amount. The threshold amount of motion may be measured or defined in a number of ways including, for example, a distance traveled in a given period of time or a speed traveled for a given time.

In another exemplary embodiment, the mobile device 10 includes a processor 13 that is configured for routing incoming calls (e.g., from the cellular network 12) received by the wireless communication system 20 to the voicemail system 25 when the motion sensing devices 14a and 14b sense a threshold amount of motion. In this regard, the configuration of the processor 13 prevents a user from becoming distracted by incoming calls, but maintains the functionality of the voicemail system 25. Exemplary processors 13 may be configured to activate a notification (e.g., an audio-only notification) via the notification system 19 in response to an incoming call and/or a new voicemail message. To this end, the unsolicited response codes that monitor incoming data and voice calls may be configured (e.g., by the processor 13) such that incoming calls are routed in a particular manner and/or the notification system 19 is activated in a particular manner.

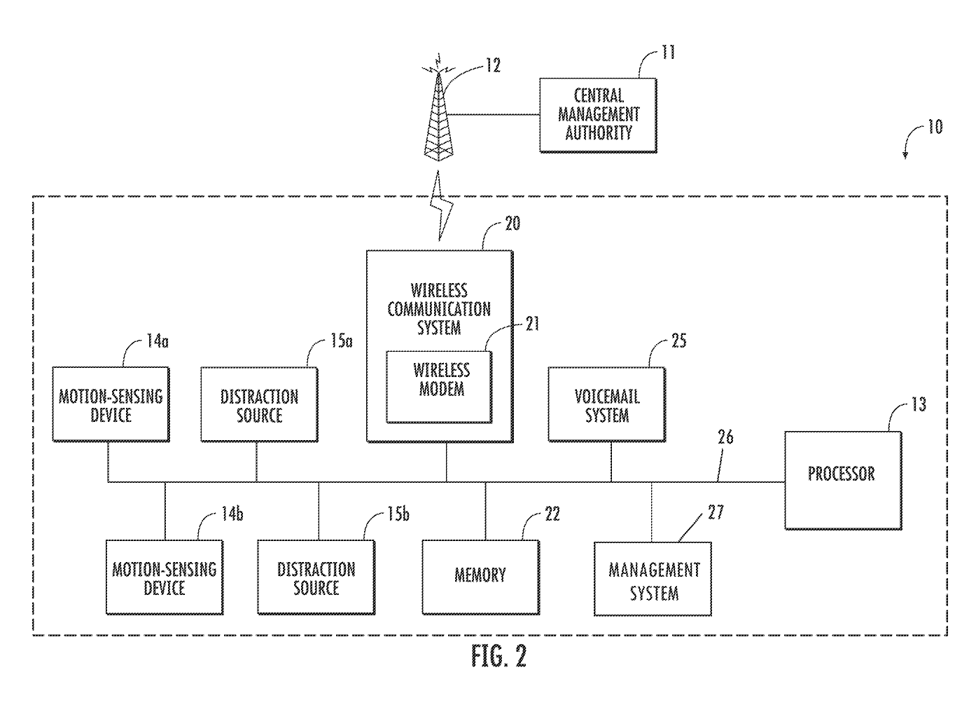

FIG. 2 schematically depicts a communication network that includes another exemplary mobile device according to the present invention. The communication network includes a central management authority 11, a cellular network 12, and an exemplary mobile device 10. The cellular network 12 is a typical radio network as described with respect to FIG. 1.

As depicted in FIG. 2, the exemplary mobile device 10 includes a processor 13, motion sensing devices 14a and 14b, distraction sources 15a and 15b, a wireless communication system 20, memory 22, a voicemail system 25, and a management system 27. The processor 13 is communicatively coupled to each of the other systems and devices.

The motion sensing devices 14a and 14b are capable of sensing that the mobile device 10 is in motion. The exemplary mobile device 10 depicted in FIG. 2 includes two motion sensing devices 14a and 14b. Other exemplary mobile devices in accordance with the present invention may include more than two motion sensing devices. Furthermore, in some exemplary embodiments, the mobile device includes only one motion sensing device.

Suitable motions sensing devices 14a and 14b, their operation, and their interaction with the processor 13 have been described with respect to FIG. 1. As noted, if the amount of motion sensed by the motion sensing device or devices 14a and 14b corresponds to or exceeds the threshold amount of motion, the processor 13 will then enable, disable, or control other systems or devices in the mobile device 10 depending on the processor's configuration.

As depicted in FIG. 2, the exemplary mobile device 10 includes two distraction sources 15a and 15b. Other exemplary mobile devices in accordance with the present invention may include more than two distraction sources. Furthermore, in some exemplary embodiments, the mobile device includes only one distraction source.

The processor 13 of FIG. 2 is configured for disabling one or more of the distraction sources 15a and 15b in response to a threshold amount of motion sensed by the motion sensing devices 14a and 14b. In exemplary embodiments, the processor 13 is configured for, after disabling one or more of the distraction sources 15a and 15b in response to a threshold amount of motion sensed by the motion sensing devices 14a and 14b, enabling the previously disabled distraction source in response to an amount of motion sensed by the motion sensing devices 14a and 14b that is less than the threshold amount.

The distraction sources 15a and 15b may include any device or feature that is capable of distracting an individual. In other words, the distraction sources 15a and 15b typically divert an individual's focus from a task being performed (e.g., driving a vehicle) to some aspect of the mobile device. Exemplary distraction sources 15a and 15b include human-readable content, a user interface, a keyboard, a voice communication system, a Bluetooth communication link, a touch screen, a notification system, a display screen, and an audio output device. As noted, the processor 13 is configured for disabling one or more of the distraction sources 15a and 15b in response to a threshold amount of motion sensed by the motion sensing devices 14a and 14b. Thus, the processor's configuration effectively prevents the user from becoming distracted by the mobile device while the mobile device is in motion.

In exemplary embodiments including a voice communication system as a distraction source, the processor may be configured for, when the voice communication system is disabled in response to a threshold amount of motion sensed by the motion sensing device, directing incoming calls to a voicemail system 25. To this end, the unsolicited response codes that monitor incoming data and voice calls may be configured (e.g., by the processor 13) such that incoming calls are routed in a particular manner.

Exemplary embodiments of the mobile device 10 include a processor 13 configured for disabling only one or two of a plurality of distraction sources in response to a threshold amount of motion sensed by the motion sensing devices 14a and 14b. In other words, the processor 13 disables some of the distraction sources, but not all of the distractions sources in the mobile device 10. For example, for a mobile device 10 including a Bluetooth communication link, the processor 13 may be configured for disabling one or more distractions sources 15a and 15b, but enabling or maintaining the functionality of the Bluetooth communication link. Thus, the processor's configuration effectively prevents the user from becoming distracted by certain distraction sources 15a and 15b, but encourages the use of or maintains the functionality of the less distracting Bluetooth communication link.

As noted, the mobile device 10 includes a wireless communication system 20. Typically, the wireless communication system 20 includes a wireless modem 21 (e.g., a radio modem) capable of communicating via signals with the cellular network 12, and may also include other types of modems such as mobile broadband modems and/or wireless data modems (e.g., a WiFi modem).

As depicted in FIGS. 1 and 2, the mobile device 10 includes a voicemail system 25. In exemplary embodiments, however, the mobile device 10 may not include a voicemail system 25. In such embodiments, the processor 13 may direct incoming calls to a voicemail system 25 via the cellular network 12.

Exemplary mobile devices 10 include a management system 27 that is communicatively coupled to the processor 13. The management system 27 is capable of changing the configuration of the processor 13 in response to instructions received by the wireless communication system 20 from the central management authority 11. In this regard, an operator controlling the central management authority 11 (e.g., a parent of a child using the mobile device or an individual responsible for managing a corporate entity's mobile devices used by employees) may send instructions (e.g., commands) via the cellular network 12 that are received by the mobile device's wireless communication system 20. The instructions may be interpreted by the management system 27 and appropriate changes may be made to the configuration of the processor 13.

Using the central management authority 11 and management system 27, an operator may remotely manage the configuration of the mobile device's processor 13. For example, an operator may send instructions such that the management system 27 configures the processor 13 to enable, disable, or control other systems or devices in the mobile device 10 when the motion sensing devices 14a and 14b sense a threshold amount of motion.

Although not specifically depicted in the figures, exemplary mobile devices in accordance with the present invention may include other hardware and devices typical of a mobile device, such as display screens, audio speakers, audio outputs, microphones, batteries, non-transitory, tangible, computer-readable storage media, power connections, and/or data connections.

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A mobile device, comprising:
a motion sensing device;
a user-interface system comprising a tactile-control system;
a wireless communication system; and
a processor communicatively coupled to the motion sensing device, the user-interface system, and the wireless communication system, the processor configured for:
disabling the user-interface system's tactile-control system in response to a threshold amount of motion sensed by the motion sensing device.

2. The mobile device according to claim 1, comprising a notification system;
wherein the processor is communicatively coupled to the notification system; and
wherein the processor is configured for disabling the notification system in response to a threshold amount of motion sensed by the motion sensing device.

3. The mobile device according to claim 1, comprising a notification system;
wherein the processor is communicatively coupled to the notification system; and
wherein the processor is configured for, when the motion sensing device senses a threshold amount of motion, activating an audio-only notification via the notification system in response to an incoming voice call or message received by the wireless communication system.

4. The mobile device according to claim 1, wherein:
the user-interface system comprises a voice-control system; and
the processor is configured for enabling the voice-control system in response to a threshold amount of motion sensed by the motion sensing device.

5. The mobile device according to claim 1, wherein:
the user-interface system comprises a voice-control system; and
the processor is configured for, when the motion sensing device senses a threshold amount of motion, enabling the voice-control system in response to an incoming voice call or message received by the wireless communication system.

6. The mobile device according to claim 1, wherein the processor is configured for, when the motion sensing device senses a threshold amount of motion, directing incoming calls to a voicemail system.

7. The mobile device according to claim 1, comprising two or more motion sensing devices and wherein the processor is configured for:
determining an amount of motion in response to data from two or more of the motion sensing devices.

8. The mobile device according to claim 1, wherein the processor is configured for, after disabling the user-interface system's tactile-control system in response to a threshold amount of motion sensed by the motion sensing device, enabling the user-interface system's tactile-control system in response to an amount of motion sensed by the motion sensing device that is less than the threshold amount.

9. The mobile device according to claim 1, wherein the motion sensing device comprises a GPS device.

10. The mobile device according to claim 1, wherein the motion sensing device comprises an assisted GPS device.

11. A mobile device, comprising:
a motion sensing device;
a wireless communication system; and
a processor communicatively coupled to the motion sensing device and the wireless communication system, the processor configured for:
routing incoming calls received by the wireless communication system to a voicemail system when the motion sensing device senses a threshold amount of motion.

12. The mobile device according to claim 11, comprising a notification system;
wherein the processor is communicatively coupled to the notification system; and
wherein the processor is configured for disabling the notification system in response to a threshold amount of motion sensed by the motion sensing device.

13. The mobile device according to claim 11, comprising a notification system;
wherein the processor is communicatively coupled to the notification system; and
wherein the processor is configured for, when the motion sensing device senses a threshold amount of motion, activating an audio-only notification via the notification system in response to an incoming call.

14. The mobile device according to claim 11, comprising:
a tactile-control system; and
a voice-control system;
wherein the processor is communicatively coupled to the tactile-control system and the voice-control system; and
wherein the processor is configured for:
disabling the tactile-control system in response to a threshold amount of motion sensed by the motion sensing device; and
enabling the voice-control system in response to a threshold amount of motion sensed by the motion sensing device.

15. A mobile device, comprising:
a motion sensing device;
a distraction source; and
a processor communicatively coupled to the motion sensing device and the distraction source, the processor configured for:
disabling the distraction source in response to a threshold amount of motion sensed by the motion sensing device.

16. The mobile device according to claim 15, wherein the processor is configured for, after disabling the distraction source in response to a threshold amount of motion sensed by the motion sensing device, enabling the distraction source in response to an amount of motion sensed by the motion sensing device that is less than the threshold amount.

17. The mobile device according to claim 15, comprising two or more motion sensing devices and wherein the processor is configured for:
determining an amount of motion in response to data from two or more of the motion sensing devices.

18. The mobile device according to claim 15, wherein the distraction source comprises a user interface.

19. The mobile device according to claim 15, comprising two or more distraction sources and wherein the processor is configured for:
disabling two or more distraction sources in response to a threshold amount of motion sensed by the motion sensing device.

20. The mobile device according to claim 15, wherein:
the distraction source comprises a voice communication device; and
the processor is configured for, when the voice communication device is disabled in response to a threshold amount of motion sensed by the motion sensing device, directing incoming calls to a voicemail system.
